(19) United States
(12) Patent Application Publication
(10) Pub. No.: US 2009/0217336 A1
(43) Pub. Date: Aug. 27, 2009

(54) Playback Resume System and Method for a Media Center

(75) Inventors: Shun-Fa Chang, Tapei City (TW); Ruei-Yan Chen, Yilan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CYBERLINK CORP., Shindian City (TW)

(21) Appl. No.: 12/035,633

(22) Filed: Feb. 22, 2008

(51) Int. Cl. H04N 7/173

(52) U.S. Cl. 725/115

(57) ABSTRACT

A playback resume system and method for a media center are described. This invention is applied to a scheme of the media center. Particularly, a personalized device capable of transmitting a proprietary identifier is used to be a controller of the media center. By means of the proprietary identifier, the invention can be implemented in a multi-user environment, and used for different playback devices or in different playback situations. Since the playback scheduled progress can be saved, the invention reaches a more convenient and fast resume purpose. The preferred embodiment includes the steps of establishing a connection between a multimedia controller and a multimedia server, and receiving a proprietary identifier and a playback command transmitted from the controller and the server. After that, the multimedia server reads the last playback multimedia data and its scheduled progress with corresponding identifier, and then resumes the playback progress.

### BACKGROUND OF THE INVENTION

1. Field of the Invention

The present invention relates to a playback resume system and method for a media center, more particularly to employ a controlling device for transmitting a user identifier, thereby to resume a multimedia playback.

2. Description of Related Art

When a regular audio/video player plays a video, a pause function can be used to stop the audio or the video at a playback position temporarily. In the meanwhile, the audio/video player is standby for a resume command by a user using a remote control or a control panel of the player. And then the player plays the video from the pause position as receiving the resume command. If a playback program installed in a computer system is used to play the video, there is no any specific function used to record the last playback position, but a drag-and-drop time axis can be used to search the last playback position conventionally.

Current new-developing home entertainment system adopts a media center structure, thereby to connect a multimedia server or computer system having a medium for storing the audio or video via networks. A user can use a controller to play the audio or video through the computer system and a built-in operating system. Further, the user can use a remote control to play the audio or video. Still further, the user can link the multimedia server by a wired or wireless network, and download the audio or video to the computer system by means of streaming.

Reference is made to FIG. 1, which shows a schematic diagram of a home entertainment system established on a media center. Several rooms of a house are shown in the diagram, wherein there is a media server 10 with kinds of audio/video content is disposed in a first room 11, and further a second room 12, a third room 13 and a fourth room 14 respectively represent a bedroom, living room and a study room. In particular, each room equips the network-enabled device that can be used to connect to the media server 10, thereby to watch the downloaded video. In addition, a home media center can be implemented since kinds of the audio/video content can be downloaded from Internet through the media server 10.

According to the structure of home entertainment system, there is a corresponding protocol configured between the media server 10 and the terminal device disposed in each room. In which, a remote control for controlling audio/video content playback is served as a digital media controller (DMC) in the media center. The digital TV, computer, or other playback device for playing the media in each room is served as a digital media renderer (DMR). The media server 10 is served as a digital media server (DMS). Under this home entertainment system, both the DMC and DMR have transmission modules with the same communication protocol, and both the DMR and DMS also use the same communication protocol. By which the audio/video content can be retrieved, recorded and stored via the DMS, and be played by the DMR that supports the playback format.

In the conventional art, if a user wants to continue the last playing, the last position should be recorded into the storage media of a computer system. For example, the playback information for the playback software is recorded into a hard disk of a computer, or any other required storage. More, a flash memory or other effect-equivalent recording means can be used to record the required playback information for the household audio/video player.

According to the aforementioned technologies applied to home audio/video player such as the DVD player, there is no any particular way to record the last playback position under different playback environment, such as the different rooms, places or devices. Thus users can only use the original player to resume the playback since pausing or stopping the previous playback. Or the users can search the previous playback record by themselves. However, if the users change the playback environment, or some other users commonly use the some audio/video playback environment, the conventional technologies do not provide any more convenient or faster approach to continue the last playback.

### SUMMARY OF THE INVENTION

Under the applications incorporating the home media center structure, several conventional arts applied to network media playback have already disclosed the approach of audio/video playback and resumption. However, by means of storing the playback information, the present invention further provides a more convenient and fast playback resumption technology under a multi-user environment, with different equipments and at different playback positions.

The embodiment of the playback resume system of the present invention is disclosed a multimedia server providing a streaming service. Further, the multimedia server has a multimedia database for storing multimedia data, and an identifier database for storing the records of identity for each user or each remote control device. Further, at least one multimedia player of the playback resume system connects with the multimedia server via network, and thereby to play the multimedia. Still further, at least one multimedia controller of the playback resume system connects to the multimedia server and transmits the identifier to the server, and used to control the multimedia server to verify the multimedia and its playback information. After that, this controller transmits the multimedia data to the multimedia player for resuming the playback.

Another embodiment of the playback resume method of the present invention includes a first step of establishing a connection among the multimedia controller, multimedia player and the multimedia server. In the meantime, the multimedia controller awakes the multimedia player and transmits the identifier. After that, the multimedia server reads the multimedia playback information with corresponding identifier, and then resumes the broadcast.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of a home entertainment center based on a media center;

FIG. 2 is a schematic diagram of the embodiment showing a frame of the media center of the present invention;

FIG. 3 is a schematic diagram of first embodiment of the resume system of the present invention;

FIG. 4 is a schematic diagram of second embodiment of the resume system of the present invention;

FIG. 5 is a schematic diagram of third embodiment of the resume system of the present invention;

FIG. 6 is a schematic diagram of fourth embodiment of the resume system of the present invention;

FIG. 7 shows a flow chart diagram for stopping playback by a multimedia server according to the present invention;

FIG. 8 shows a flow chart diagram for resuming broadcast by a multimedia server according to the present invention;

FIG. 9 shows a flow chart diagram for resuming playback by a multimedia server according to the present invention;

FIG. 10A shows a flow chart diagram for resuming broadcasting by a multimedia server according to the present invention;

FIG. 10B shows a flow chart diagram for storing the playback information by a multimedia server according to the present invention.

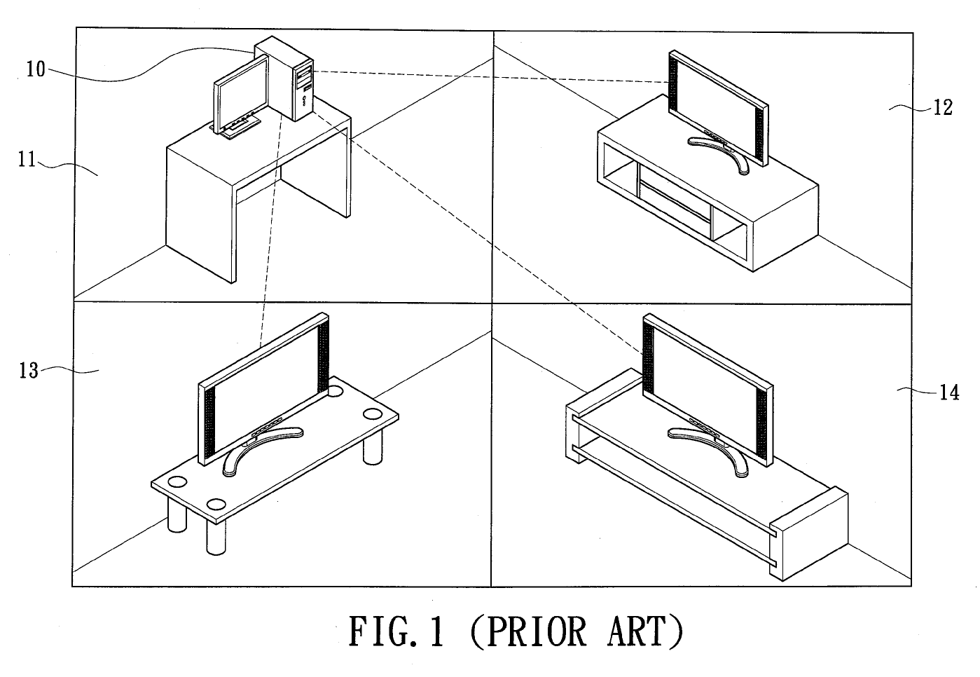

### DETAILED DESCRIPTION OF THE PREFERRED EMBODIMENTS

The present invention is illustrated with an embodiment and attached drawings. However, the invention is not intended to be limited thereby.

The playback resume system and the method thereof of the present invention are incorporated in multimedia playback by means of network streaming. If any pausing or stopping is needed, the playback information can be recorded in addition to pause or stop the multimedia. Thus, even the multimedia playing environment is changed, the last playback position can be resumed based on an identifier with corresponding user or remote control for multi-user environment.

For playing a personalized multimedia in a multi-user environment, a multimedia server, such as a computer system, is provided for storing the multimedia data and records of identity in a media center. In the embodiment, the multimedia server will perform a digital signal operation, network connection, user ID management, multimedia broadcasting, and signal retrieval. The multimedia server further has a database system for storing and managing the multimedia data. The embodiment of the computer system and the database system can be combined with another multimedia server, or forms a standalone computer system and a standalone database server.

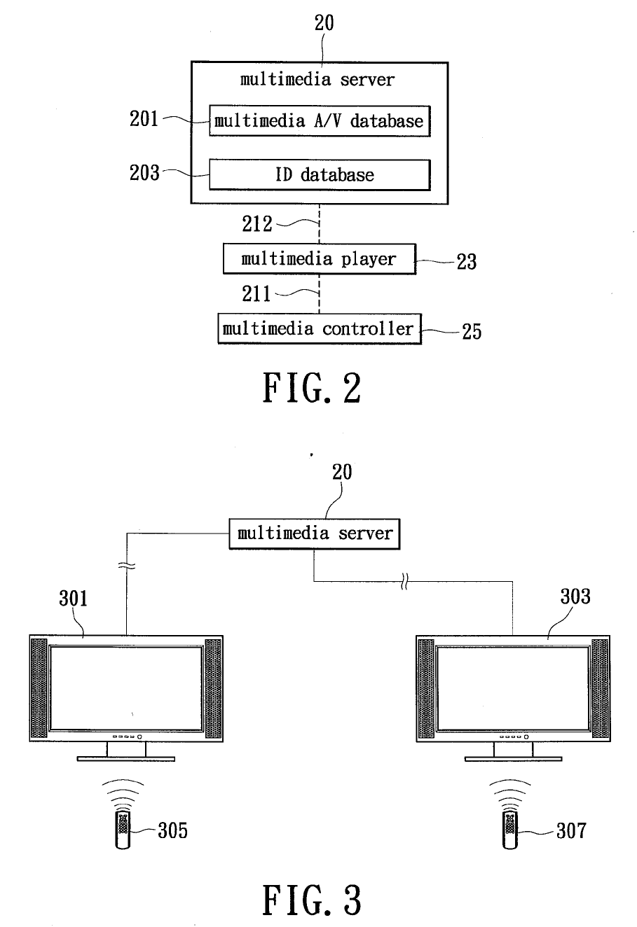

The playback resume system of the media center of the present invention is applied to the home entertainment system, in which the multimedia server is implemented as DMS that is used to store and transmit kinds of the audio/video streaming data, and the multimedia player is implemented as DMR that is used to broadcast the streaming data transmitted from the server, and the multimedia controller is implemented as DMC that is a controller of the home entertainment center. The schematic diagram of the embodiment of the present invention is shown in FIG. 2.

Under the home entertainment system shown in FIG. 2, a remote control for controlling the multimedia playback is performed in the role of the multimedia controller 25 in a media center. The remote control connects to a multimedia playback device, such as a multimedia player 23, via a first link 211. Next, the multimedia player 23 connects to a multimedia database, which is implemented as a multimedia server 20 of the home entertainment system, disposed at local or remote end via a second link 212. That is, the multimedia server 20 can provide a streaming service locally or remotely via Internet.

Under this home entertainment system, both the multimedia controller 25 and multimedia player 23 employ the same protocol. The connection is accomplished by the first link 211 that can be any type of wireless protocol, and be capable of carrying the identifier to the multimedia server 20. In particular, the identifier can be embodied as an RFID.

Both the multimedia player 23 and the multimedia server 20 equip the transmission modules with the same protocol for the bi-directional link 212. By the second link 212, users can retrieve the multimedia data using file download or stream download through the multimedia server 20, and executes other functionalities such as to record or store multimedia data. More, the multimedia player 23 supporting any required playback format plays the multimedia. Externally, the multimedia server 20 employs TCP/IP network protocol to connect to Internet, and internally employs UPnP interface standard to connect with one or more multimedia players 23 via the second link 212. Further, the mentioned multimedia server 20 includes a multimedia database 201 and an identifier database203. The multimedia database 201 stores the multimedia data. The identifier database 203 stores the records of identity for each remote control or for each user, and stores the records of playback information associated with one of the identity records. The record of playback information includes a position of multimedia data, such as which media is selected and the last played position of the selected media. The record of playback information may also include the parameters of multimedia player or the parameters of the multimedia data, such as the volume of the audio output, the parameters of audio equalizer, and the view angle of the multimedia data. After recognizing the users or the multimedia controller 25, the identifying means is incorporated into enquiring and determining the corresponding record of playback information. The method to recognize the user may be achieved by indicating which the record of identity stored in the database 203 is matched to the identifier transmitted from the user, for example. Thereby the system provides each user the personalized storing service for storing the record of playback information, and the next request from the user to determine the playback information for conveniently and playback resuming. For example, the user favoring the heavy metal music may resume the personalized parameters of audio equalizer without manual control.

Particularly, the multimedia controller 25 connects to the multimedia server 20 via the multimedia player 23, and transmits many kinds of broadcast control signals, such as the multimedia selection, playback, pause, stop, fast/slow, or forward/backward. The controller 25 further transmits an exclusive identifier of the multimedia controller 25 to the multimedia server 20 so as to control the multimedia server 20 to transmit the multimedia data with corresponding identifier, and store the corresponding playback information. The mentioned identifier can be implemented as a set of user ID/password, or a biometric verification with personal biometric characteristics, such as, but not limited to, the fingerprint, voice print, or the identification data recorded in an IC card.

The embodiment of the playback resume system of a media center of the present invention is as follows:

Embodiment 1, the home media center:

The multimedia server 20 is used to implement the playback resume system that is shown as a media center in FIG. 3, the one of the embodiments of the present invention. The multimedia server 20 is a database that is for storing the multimedia data and the records of identity locally. The multimedia server 20 connects with one or a plurality of terminal devices via network connection. The terminal devices, such as a first terminal device 301 and a second terminal device 303 shown in the drawing, can be the home appliances—digital TV, computer, or hand-held device connecting with the multimedia server 20. In this embodiment of the present invention, the multimedia server 20 and the terminal devices are equipped with the opposite protocols. The remote controls 305, 307 are performed in a role of DMC under the structure of home media center, and usually being a control device. The terminal devices 301, 303 are performed in a role of DMR for playing the multimedia. Further, the multimedia server 20 is performed in a role of DMS for broadcasting the multimedia. In the operation of the home media center, both DMC and DMR are equipped with the transmission modules having the same protocol. After that, the DMS is used to retrieve, record and store the multimedia data, which is played by the DMR supporting the related format.

Under the structure of this embodiment, when remote controls 305, 307 serving as the DMC detect the terminal devices 301, 303 performing as the DMR, such as an RFID is used to achieve the connection between DMC and DMR, the DMC will awake the standby DMR. Next, the DMS will broadcast the multimedia to DMR. If the user changes the broadcast state, DMC will receive the relevant message and transmit to the DMR.

Otherwise, if the DMR doesn't detect the DMC, such as the user leaves an effective distance apart or turns the control device off, the DMR will be shut down and enter a standby mode. On the contrary, if the DMC approaches the DMR, the DMR will be activated automatically. One of the functions is to resume the playback from the previous recording position instantly without any button press.

The user can use the first remote control 305 to control playing behavior of the first terminal device 301 by means of wired or wireless connection. The other user can use the second remote control 307 to control the second terminal device 303. When the users manipulate the remote controls, the identifier for the remote control is sent out. As the multimedia server 20 receives the identifier sent via the network, the identifier—the identifying means is used to identify the remote control and read out the playback information with corresponding identifier. After that, the previous playback information will be resumed by the playing means as requesting resuming the playback. Since the first remote control 305 and the second remote control 307 are portable, the multimedia can be resumed at any place. If the user requests resuming playback using the first remote control 305 in front of the second terminal device 303, the multimedia server 20 will determine the playback information with corresponding identifier and broadcast it correctly.

In particular, the mentioned first remote control 305 and second remote control 307 are not limited to the regular home-used remote control for the television or computer, but also for every kind of device capable of generating the proprietary identifier, such as the mobile phone, PDA, notebook computer or other personal mobile device having the equivalent effect. The identifier can be implemented as an identification data for the remote control, user ID/password, personal biometric identifier or an IC card.

Embodiment 2, the home media center:

Other than the embodiment 1, that is, when the remote control (305 or 307) served as DMC detects the terminal device (301 or 303) served as DMR, the DMC will awake the DMR to download the multimedia. In the current embodiment, the DMR isn't awaked until the remote control (305 or 307) served in the role of DMC sends out the activation or playback command.

Embodiment 3, streaming down the multimedia via Internet:

With the network bandwidth increases, more multimedia device can play the multimedia via the network, and also more video or audio can be retrieved via the network.

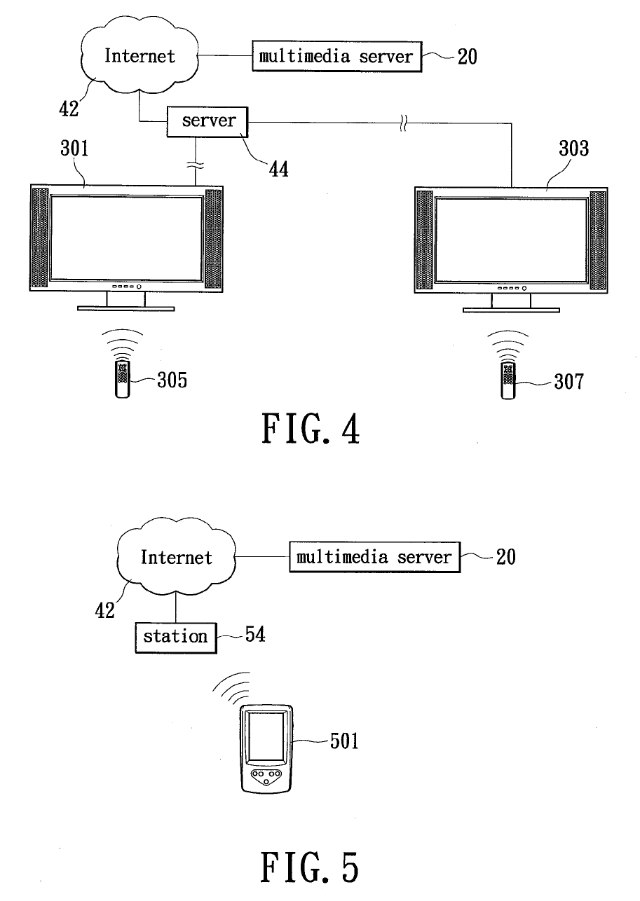

Reference is made to FIG. 4 showing a schematic diagram of the embodiment 2 of the present invention. The multimedia server 20 is disposed at a remote side, and the terminal device, such as the first terminal device 301 and the second terminal device 303, at a user end connect with the multimedia server 20 through a local server 44 and Internet 42. On or more users at the user end use the first remote control 305 to control the first terminal device 301 by means of wired or wireless connection, and use the second remote control 307, but not limited to, to control the second terminal device 303.

In view of this embodiment, as the user uses the personal device to download the multimedia, a request for playing the multimedia will be sent to the multimedia server 20 from the local server 44 via Internet 42, and the identifier is transmitted. After that, the multimedia server 20 determines the previous playback information with corresponding identifier, and broadcasts the scheduled multimedia data to the terminal devices (301 or 303) through the local server 44 and Internet 42.

Embodiment 4, a personal mobile device connecting to the multimedia server for streaming down the multimedia by means of wireless connection:

Reference is made to FIG. 5 showing a schematic diagram of the playback resume system of the home media center. A personal mobile communication device 501 is used for streaming down the multimedia. For achieving the playback resuming, the user uses the mobile communication device 501 to transmit the identifier, which has a proprietary identification for the mobile communication device 501, communication number, user ID/password or personal biometric ID. By means of the kinds of wireless network protocols, such as IEEE802.x, GPRS, 3G and the like, the mobile communication device 501 connects to a wireless station 54, and connects to the remote multimedia server 20 to request streaming down the multimedia via Internet 42. In the meantime, the identifying means in the multimedia server 20 responds a corresponding record of playback information with corresponding identifier, and resumes the playback. In the exemplary embodiment, the multimedia is downloaded through the mobile communication device 501, and can be watched or listened by the device 501. Therefore, the mobile communication device 501 of the embodiment has the functionalities of the multimedia controller and multimedia player.

Embodiment 5, the vehicle entertainment system:

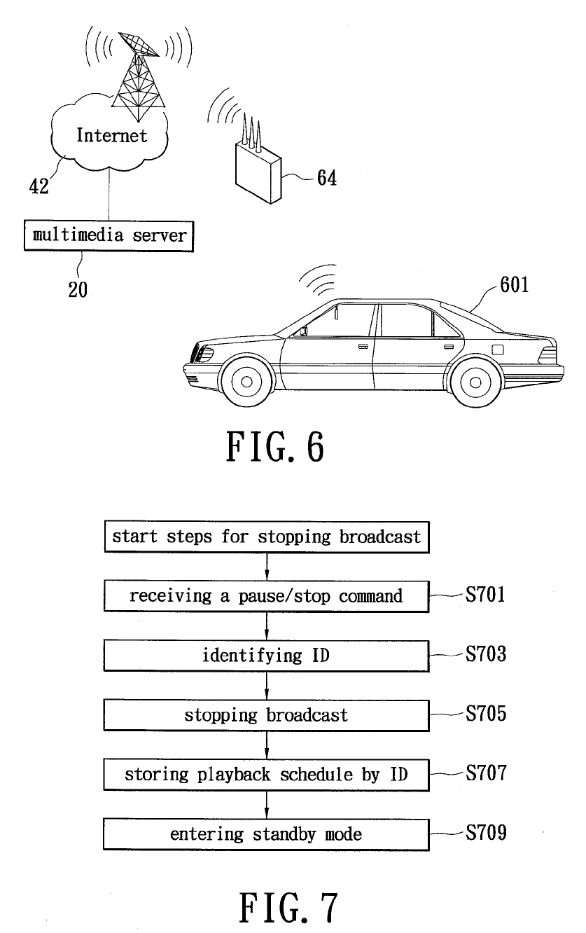

The mentioned personal device can be introduced to the entertainment environment of a vehicle 601 shown in FIG. 6. Since the multimedia download environment is getting well developed, a running vehicle 601 can use the wireless communication to download the multimedia. In the exemplary embodiment, a multimedia player in the running vehicle 601 connects to a station 64 by means of wireless connection, and also connects to the multimedia server 20 via Internet 42. In the progress, users may resume the playback by transmitting the personal identifier, verifying the received personal identifier, and broadcasting the content corresponding with the verified identifier.

FIG. 7 shows an embodiment of the media center that the multimedia server stops broadcasting the multimedia:

In the beginning, the broadcasting process starts. The broadcast stops when a user executes a pause or stop command for the broadcast, or the system sends out the stop signal as meeting an accident event, such as power failure, the network interruption or any device damage, the multimedia server will receive the pause or stop command. (step S701).

When the multimedia broadcast is in progress, the multimedia server records the current in-used identifier. Meanwhile, the server identifies which record of identity is matched with the identifier transmitted from user when it receives the pause or stop command or signal (step S703). After identifying the identifier, the broadcast stops (step S705). Next, the current playback information, such as the title/identity of the current playback media, and the current position of the current playback media, is saved according to the identifier (step S707). After that, the server enters standby mode (step S709), and listens to other commands.

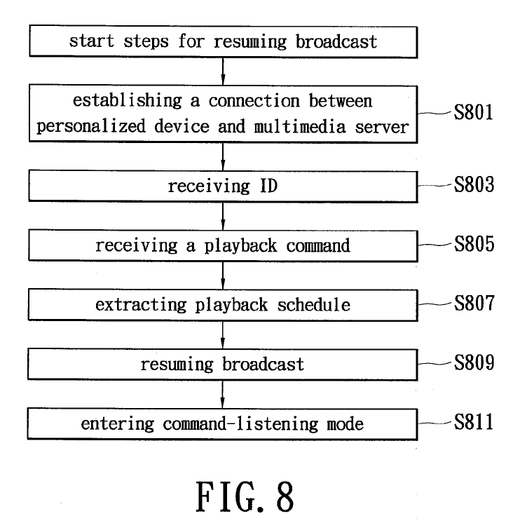

FIG. 8 shows a flow chart for the broadcasting from the multimedia server of the present invention:

When a user uses a personal device (or personalized mobile communication device) to play the multimedia via network, firstly, the connection between the personal device and the multimedia server should be established as the broadcast process starts (step S801). In the meantime, the multimedia server receives an identifier including a proprietary ID for the personal device, a set of user ID and password for the personal device, personal biometric ID or other identification from the personal device (step S803). Particularly, the personal device performs in a role of playback from a remote server.

Next, the multimedia server receives a playback command (step S805), especially the playback resume command. Then the server reads a record of playback information with corresponding to the previously received identifier (step S807), and resumes the playback afterwards (step S809). A UPNP interface standard is employed to link to one or a plurality of terminal devices in the embodiment, and thereby to play the multimedia.

When the broadcast is in progress, the multimedia server enters a command-listening mode for further instructions (step S811).

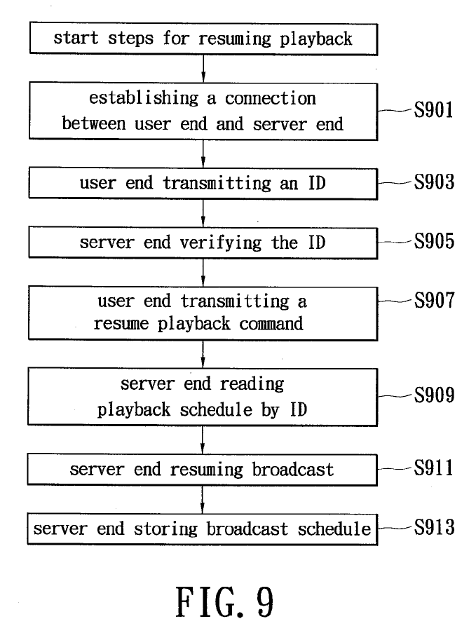

FIG. 9 shows a flow chart of the embodiment of the present invention. The flow of the embodiment separates the playback resume system into a user end using a personalized device and a server end capable of receiving identifier and broadcasting multimedia.

In the user end, the personalized device is used to perform a multimedia playback command. When the resume playback starts, a connection between the user end and the server end is established (step S901). The connection establishment can be implemented as a three-way handshake procedure. After establishing the connection, the user end transmits an identifier to the server end (step S903). Then the server end verifies the identifier (step S905). After that, the server end sends a verification signal.

Next, the personalized device in the user end transmits a resume playback command (step S907). Then the server end reads a record of playback information (step S909), and resumes broadcasting multimedia (step S911).

After that, the server end records the playback information for each user end (step S913). The step S913 can be embodied by variant methods. The server end records the current playback information as the user end sends the pause or stop command. To consider the sudden connection interruption, the server end periodically records the playback information with corresponding identifier for presenting late for generating the pause or stop command. So that, the server can resume and broadcast the multimedia according to the latest recorded playback information after the interrupt accident.

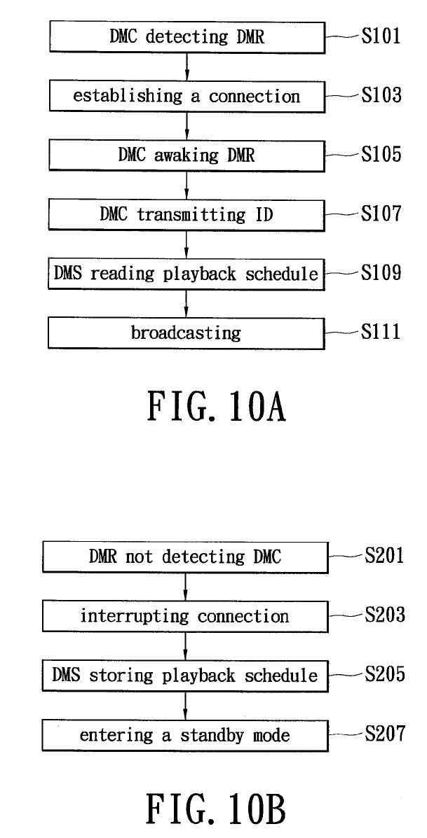

A further embodiment of the playback resume method of the present invention is shown in FIGS. 10A and 10B. This flow is applied to a home entertainment system. A multimedia server connects to the terminal devices at different positions by a network. Where a remote control performs in a role of DMC for controlling the multimedia playback, and the terminal devices, such as the digital television, computer or the like, play in a role of DMR, and the local or remote multimedia server performs in a role of DMS for providing the multimedia download services.

Refer to the flow shown in FIG. 10A, when the remote control served as DMC detects the terminal device(s) performed as DMR in the beginning (step S101), the connection between the DMC and DMR is established, including the connections among the DMRs (step S103). In the meantime, the DMC awakes the DMR from standby (step S105), and transmits the multimedia information to DMR, including the identifier for DMC or the mentioned user ID (step S107). Next, the DMS receives the identifier transmitted from the DMC, and reads the record of playback information with corresponding identifier (step S109). The multimedia is transmitted to user device via DMR (step S111). As the broadcast is in progress, if the user changes the playback state, the related messages are sent through DMC to DMR and to DMS afterwards. Please note that the connection between the DMC and DMR is established if the terminal device detects at least one remote controller existing. Then, the DMR awakens from the stand-by mode and continues the other steps for multimedia playback.

Reference is made to FIG. 10B, which discloses a process as the DMC leaves the DMR a distance apart. In step S201, if the DMR fails to detect the DMC as broadcasting the multimedia, for example, the user leaves, the remote control or player is shut down. Then the DMR interrupts the connection to the DMC automatically (step S203). Further, the DMS records the playback information (step S205). Then the DMR and DMS enter a standby mode or be shut down (step S207). On the contrary, if the DMC approaches the DMR again, such as the flow shown in FIG. 10A, the DMR will be activated automatically. In particular, the provided function of the present invention continues the playback from the previous recorded playback position instantly without any further button press.

The aforementioned DMC can be the personalized device capable of transmitting proprietary identifier such as the remote control, computer, mobile phone and the like. When the user carries the DMC approaching the DMR, the multimedia will be resumed through the mentioned flow without a series of complicated operation steps. So that, the method provided by the present invention can reduce the complex steps to search the previous playback information. Furthermore, if the user carries the DMC leaving an effective distance apart, the broadcast stops.

In summation of description above, the present invention is to provide an playback resume system and method for the media center. If the broadcast needs to be paused or stopped as the multimedia is streaming via network, the multimedia server will record the playback information and provide playback resuming from the previous playback position even though the user changes the playback environment.

While the invention has been described by means of a specification with accompanying drawings of specific embodiments, numerous modifications and variations could be made thereto by those skilled in the art without departing from the scope and spirit of the invention set forth in the claims.

What is claimed is:

1. A playback resume system, comprising:
a multimedia server providing a streaming service, further comprising:
a multimedia database for storing multimedia data; and
an identifier database for storing at least one record of identity, and at least one record of playback information mapping to the record of identity;
at least one multimedia player connecting with the multimedia server via a network to play the multimedia; and
at least one multimedia controller connecting to the multimedia server and transmitting the identifier to the multimedia server,
wherein the multimedia server verifying whether the identifier is matched with the record of identity and providing the multimedia data in streaming in response to the record of identity and the record of playback information of the identifier database.

2. The system of claim 1, wherein the multimedia controller transmitting the identifier to the multimedia server through the multimedia player and the network.

3. The system of claim 1, wherein the record of playback information comprising a parameter of the multimedia data.

4. The system of claim 1, wherein the record of playback information comprising a position related to the multimedia data.

5. The system of claim 4, wherein the multimedia server provides the multimedia data according to the position related to the multimedia data if the multimedia server received a playback command from the multimedia controller.

6. The system of claim 4, wherein the identifier database stores the position of the multimedia data and stops providing the multimedia data if the multimedia server received a pause command or a stop command from the multimedia controller.

7. The system of claim 1, wherein the record of playback information comprising a parameter of the multimedia player.

8. The system of claim 1, wherein the multimedia controller and the multimedia player are disposed in a mobile communication device capable of transmitting the identifier.

9. The system of claim 1, wherein the identifier is implemented as at least one of following types, including:
a set of ID and password for a user;
personal biometric ID for the user; and
identification data stored in an IC card.

10. An playback resume method for a media center, comprising:
establishing a connection between a multimedia controller and a multimedia server;
receiving an identifier transmitted from the multimedia controller;
receiving a playback command transmitted from the multimedia controller;
reading a last played multimedia data and a record of playback information associated with the identifier; and
transmitting the last played multimedia data and the record of playback information to a multimedia player, and resuming a playback.

11. The method of claim 10, wherein the connection between the multimedia controller and the multimedia server is established by the multimedia player or a network connection.

12. The method of claim 10, wherein the multimedia server provides at least one of the following types of services, including:
a streaming service to at a local end; and
a streaming service via Internet at a remote end.

13. The method of claim 10, wherein the multimedia server uses a universal plug and play (UPnP) interface standard to connect with at least one multimedia player, and broadcast the multimedia via the multimedia player.

14. The method of claim 10, wherein the identifier is implemented as at least one of the following types, including:
a set of user ID and password for a user;
personal biometric ID for the user; and
identification data stored in an IC card.

15. The method of claim 10, wherein the multimedia controller is a personal device capable of transmitting the identifier.

16. The method of claim 10, wherein the multimedia controller is a remote control capable of transmitting the identifier.

17. The method of claim 10, wherein the multimedia controller and the multimedia player are disposed in a mobile communication device capable of transmitting the identifier.

18. The method of claim 10, wherein the method further comprising:
receiving a pause or stop command;
verifying the identifier corresponding with the command;
storing a record of playback information associated with the identifier; and
stopping the broadcast.

19. An playback resume method for a media center, comprising:
establishing a connection among the multimedia controller, the multimedia player and a multimedia server;
awaking the multimedia player;
transmitting an identifier from the multimedia controller;
reading a record of playback information associated with the identifier; and
transmitting the multimedia data to the multimedia player so as to resume playing the multimedia.

20. The method of claim 19 wherein establishing a connection among the multimedia controller, the multimedia player and a multimedia server if a multimedia player detected a multimedia controller.

21. The method of claim 19 wherein establishing a connection among the multimedia controller, the multimedia player and a multimedia server if a multimedia controller detected a multimedia player.

22. The method of claim 19 wherein the step of transmitting the multimedia further comprising:
detecting if the multimedia controller existing;
interrupting the connection between the multimedia player and the multimedia server if no multimedia controller existing;
the multimedia server storing the record of playback information associated with the identifier if no multimedia controller existing; and
the multimedia player entering a standby mode if no multimedia controller existing.

23. The method of claim 19, wherein the identifier between the multimedia controller and the multimedia player is implemented as an RFID.

24. The method of claim 19, wherein the identifier is at least one of the following types, including:
a set of user ID and password for a user;
personal biometric ID for the user; and
identification data stored in an IC card.
